(19) United States
(12) Patent Application Publication
(10) Pub. No.: US 2019/0205988 A1
(43) Pub. Date: Jul. 4, 2019

(54) COMPUTERIZED METHODS AND SYSTEMS FOR ADMINISTERING AN ADVISORY-FEE REBATE BASED ON MUTUAL FUND HOLDINGS

(71) Applicant: American Century Proprietary Holdings, Inc., Kansas City, MO (US)

(72) Inventors: Charles Alfred ETHERINGTON, Loch Lloyd, MO (US); Jay William HUMMEL, Overland Park, KS (US)

(21) Appl. No.: 16/233,033

(22) Filed: Dec. 26, 2018

Related U.S. Application Data
(60) Provisional application No. 62/611,814, filed on Dec. 29, 2017.

(51) Int. Cl. G06Q 40/06; G06Q 30/02

(52) U.S. Cl. CPC G06Q 40/06; G06Q 30/0216

(57) ABSTRACT

A computerized system for administering an advisory-fee rebate of account-level advisory fees with respect to a managed portfolio of mutual-fund investments (represented by tickers) is provided. The system comprises a management-fee calculation module adapted for calculating an average management-fee percentage for a period for each ticker in the portfolio. The system further comprises a balance-calculation module adapted for calculating a daily average balance for the period for each ticker in the portfolio. The system further comprises a rebate-calculation module adapted for calculating a rebate for each ticker in the portfolio based on the average management-fee percentage and the daily average balance and for calculating a total rebate based on the rebate for each ticker. The total rebate may then be credited to an investor account for the portfolio. Similarly, a computerized method is provided.

### CROSS-REFERENCE TO RELATED APPLICATIONS

This application claims priority on Provisional U.S. Patent Application Ser. No. 62/611,814, filed Dec. 29, 2017, titled COMPUTERIZED METHODS AND SYSTEMS FOR ADMINISTERING AN ADVISORY-FEE REBATE BASED ON MUTUAL FUND HOLDINGS which is hereby incorporated by reference in its entirety.

### BACKGROUND

### 1. Field of the Disclosed Subject Matter

The present invention relates to computerized systems and methods for use in the investment-advisory field, more particularly, for providing an advisory-fee rebate.

### 2. Background

Generally, investment advisors provide investment advice and advisory services to investors. Investors then make investments based on that advice. Such investments may include the purchase of mutual funds, stocks, or bonds. Each investment is typically represented by a ticker. An investor's investments are referred to as a portfolio.

Investment advisors typically charge investors an advisory fee for providing investment advice. In addition, certain investments, such as mutual funds, may charge a management fee that is passed along to the investor. This may problematically result in multiple layers of fees or double charging (or the appearance of double charging) for advice, while investors desire to reduce or eliminate such fees. This problem is exacerbated where the advice involves proprietary products with their own underlying fees. This problem is also exacerbated by legal and regulatory constraints that regulate how fees may be charged. This problem is further exacerbated by potential disclosure requirements, particularly for retirement accounts, and the general desire for increased transparency of fees and expenses. In addition, investment advisors and broker-dealers may receive compensation, reimbursements or other payments from mutual fund advisors or the mutual fund directly, which may not be known or disclosed to the investors. This may create complexity to investment advice generally and may create conflicts (or the appearance of conflicts) between the investor and the investment advisor or broker-dealer. In addition, this complexity and potential conflicts may vary depending on the underlying investments and the individual investment advisor or broker-dealer.

Accordingly, there is a need for a solution that reduces multiple layers of fees and simplifies advisory fees generally. There is further a need for a solution that complies with various legal regulations. There is still further a need for a solution that is scalable.

### SUMMARY

In a preferred embodiment of the present invention, a computerized method for computing a rebate of account-level advisory fees with respect to a managed portfolio of mutual-fund investments (represented by tickers) is provided. The method comprises calculating an average management-fee percentage for a period for each ticker in the portfolio. The method further comprises calculating a daily average balance for the period for each ticker in the portfolio. The method further comprises calculating a rebate for each ticker in the portfolio based on the average management-fee percentage and the daily average balance. The method further comprises calculating a total rebate based on the rebate for each ticker. The method further comprises crediting the total rebate to an investor account for the portfolio.

In other embodiments, the above step of calculating a rebate comprises multiplying the average management-fee percentage by the average balance. In yet other embodiments, the above step of crediting the total rebate comprises issuing a refund for the total rebate. In still yet other embodiments, the above step of crediting the total rebate comprises reinvesting the total rebate in the portfolio.

In another embodiment, a computerized system for computing a rebate of account-level advisory fees with respect to a managed portfolio of mutual-fund investments (represented by tickers) is provided. The system comprises a management-fee calculation module adapted for calculating an average management-fee percentage for a period for each ticker in the portfolio. The system further comprises a balance-calculation module adapted for calculating a daily average balance for the period for each ticker in the portfolio. The system further comprises a rebate-calculation module adapted for calculating a rebate for each ticker in the portfolio based on the average management-fee percentage and the daily average balance and for calculating a total rebate based on the rebate for each ticker. Wherein, the total rebate may be credited to an investor account for the portfolio.

### BRIEF DESCRIPTION OF THE DRAWINGS

The present disclosed subject matter is described herein with reference to the following drawing figures, with greater emphasis placed on clarity rather than scale:

FIG. 1 is block diagram of rebate engine 100 for calculating a rebate of account-level advisory fees exemplified in communication with account-data repository 20 in accordance with a preferred embodiment of the present invention.

FIG. 2 is flow chart depicting computerized method 200 for calculating a rebate of account-level advisory fees in accordance with a preferred embodiment of the present invention.

### DETAILED DESCRIPTION

Refer now to the drawings wherein depicted elements are, for the sake of clarity, not necessarily shown to scale and wherein like or similar elements are designated by the same reference numeral through the several views. In the interest of conciseness, well-known elements may be illustrated in schematic or block diagram form in order not to obscure the present invention in unnecessary detail, and details concerning various other components known to the art, such as computers, electronic processors, and the like necessary for the operation of many electrical devices, have not been shown or discussed in detail inasmuch as such details are not considered necessary to obtain a complete understanding of the present invention, and are considered to be within the skills of persons of ordinary skill in the relevant art. Additionally, as used herein, the term “substantially” is to be construed as a term of approximation.

It is noted that, unless indicated otherwise, all functions described herein may be performed by one or more processors, such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

In the preferred embodiment of the present invention, a computerized system for computing a rebate of account-level advisory fees with respect to a managed portfolio of mutual-fund investments is provided. In the preferred embodiment, it is contemplated that an investment advisor manages the portfolio on behalf of an investor and that the investment advisor is also the fund manager for the underlying mutual-fund investments. Alternatively, the fund manager may be an affiliate of the investment advisor or an unrelated party. In the preferred embodiment, the investment advisor charges an account-level advisory fee and a mutual fund management fee for certain mutual-fund investments. Alternatively, the investment advisor charges an account-level advisory fee and an affiliated fund manager charges a mutual fund management fee for certain mutual fund investments.

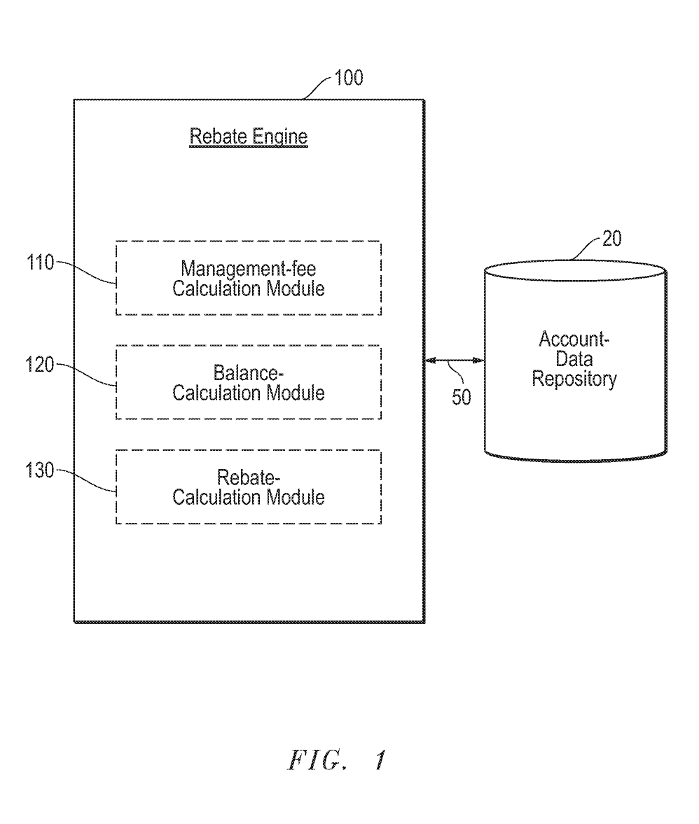

Referring to FIG. 1, a block diagram is provided of rebate engine 100 exemplified being in communication with account-data repository 20 via communications channel 50. Rebate engine 100 calculates a total rebate for a managed portfolio of mutual-fund investments for an investor for a specific period of time (preferably quarterly). Account-data repository 20 stores data related to one or more investors' investments being managed by the investment advisor. Preferably, account-data repository 20 contains a list of mutual-fund investments in the managed portfolio and additional account information (such as number of shares owned, purchase and sale dates, etc.) for each mutual-fund investment. In the preferred embodiment, account-data repository 20 is a proprietary repository or database of the investment advisor. Account-data repository 20 also stores information related to management fees charged by each mutual fund. This management-fee information may be manually input and updated by the investment advisor, or in an alternate embodiment, this management-fee information may be provided by a third party. Exemplary commercial providers of such data include FactSet or Morningstar.

Rebate engine 100 comprises management-fee calculation module 110, balance-calculation module 120, and rebate-calculation module 130. Rebate engine 100 receives a list of mutual-fund investments (represented by tickers) in the managed portfolio from account-data repository 20. Management-fee calculation module 110 retrieves management-fee information from account-data repository 20 and calculates an average management-fee percentage for each ticker in the managed portfolio. In the preferred embodiment, the average management-fee percentage for each ticker, f, is calculated by taking the sum of all the management-fee percentages charged each calendar day for the preceding quarter, DF, divided by the number of days in that period, d, in accordance with the following equation:

$$f = \frac{\sum DF}{d} \qquad ( 1 )$$

Balance-calculation module 120 receives account information from account-data repository 20 via communications channel 50 for each ticker in the managed portfolio. In the preferred embodiment, the account information includes daily account balances for each ticker. Balance-calculation module 120 calculates an average daily balance, b, by taking the sum of all daily balances by ticker, DB, divided by the number of days in that period, d, preferably on a quarterly basis and preferably using the following equation:

$$b = \frac{\sum DF}{d} \qquad ( 2 )$$

Rebate-calculation module 130 calculates a per-ticker rebate for each ticker in the managed portfolio. In the preferred embodiment, the per-ticker rebate, r, is calculated quarterly according to the following equation:

r=b×f (3)

Rebate-calculation module 130 then calculates a total rebate for the managed portfolio. In the preferred embodiment, the total rebate, R, is calculated according to the following equation:

R=Σr (4)

The total rebate of the investment advisory fee for the period, along with any additional payments or credits, is then credited to the investor's account and included in quarterly reports to the investor.

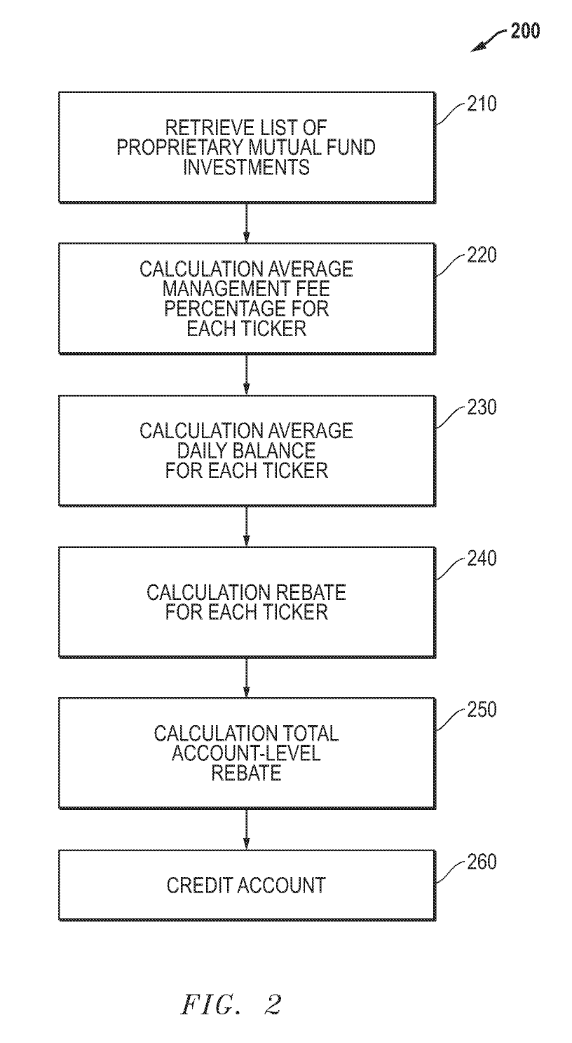

Referring to FIG. 2, a flow chart depicting computerized method 200 for calculating a rebate of account-level advisory fees for a managed portfolio of mutual-fund investments for an investor for a specific period of time (preferably quarterly) is provided in accordance with a preferred embodiment of the present invention. At step 210, a list of mutual-fund investments (represented by tickers) is retrieved. Next at step 220, an average management-fee percentage for each ticker is calculated. Preferably, the average management-fee percentage for each ticker is calculated in accordance with Equation 1 above as described above. Next at step 230, an average daily-balance for each ticker is calculated. Preferably, the average daily-balance for each ticker is calculated in accordance with Equation 2 above as described above. Next at step 240, a rebate indicative of the management fee for each ticker is calculated. Preferably, the rebate for each ticker is calculated in accordance with Equation 3 above as described above. Next at step 250, a total account-level rebate is calculated. Preferably, the total account-level rebate is calculated in accordance with Equation 4 above as described above. Last, the total account-level rebate, along with any additional credits, are applied or credited to the investor's account (step 260).

In other embodiments, the above calculations may be performed in differing order or simultaneously as is apparent to one of ordinary skill in the art. In yet other embodiments, the various functions of rebate engine 100 or method 200 may be distributed and need not be performed at a single location or by a single machine.

In the preferred embodiment, rebate engine 100 is implemented using Java (or a similar programming language). Account-data repository 20 is implemented using an appropriately configured relational database such as one provided by Oracle Corp. Rebate engine 100 is preferably implemented on a computer or server configured with Linux (or similar) operating system and is configured to execute at a regularly determined time-period (preferably quarterly). Communications between rebate engine 100 and account-data repository 20 over communications channel 50 preferably use Secure File Transfer Protocol (SFTP).

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A computerized method for computing a rebate of account-level advisory fees with respect to a managed portfolio of mutual-fund investments (represented by tickers) comprising the steps of:
calculating an average management-fee percentage for a period for each ticker in the portfolio;
calculating a daily average balance for the period for each ticker in the portfolio;
calculating a rebate for each ticker in the portfolio based on the average management-fee percentage and the daily average balance;
calculating a total rebate based on the rebate for each ticker; and
crediting the total rebate to an investor account for the portfolio.

2. The computerized method according to claim 1, wherein the step of calculating a rebate comprises multiplying the average management-fee percentage by the average balance.

3. The computerized method according to claim 1, wherein the above step of crediting the total rebate comprises issuing a refund for the total rebate.

4. The computerized method according to claim 1, wherein the above step of crediting the total rebate comprises reinvesting the total rebate in the portfolio.

5. A computerized system for computing a rebate of account-level advisory fees with respect to a managed portfolio of mutual-fund investments (represented by tickers) comprising:
a management-fee calculation module adapted for calculating an average management-fee percentage for a period for each ticker in the portfolio;
a balance-calculation module adapted for calculating a daily average balance for the period for each ticker in the portfolio;
a rebate-calculation module adapted for calculating a rebate for each ticker in the portfolio based on the average management-fee percentage and the daily average balance; and
the rebate-calculation module adapted for calculating a total rebate based on the rebate for each ticker,
wherein, the total rebate is credited to an investor account for the portfolio.

6. The computerized system according to claim 1, wherein the rebate-calculation module is adapted to calculate the rebate for each ticker by multiplying the average management-fee percentage by the daily average balance.
